(19) United States
(12) Patent Application Publication
(10) Pub. No.: US 2005/0136822 A1
(43) Pub. Date: Jun. 23, 2005

(54) Vent assembly for a vehicle refrigerator

(76) Inventors: John M Antos, Ann Arbor, MI (US); Alfard L. Jansen, Ek Den Haag (NL); David W. Leistner, Sidney, OH (US)

Correspondence Address: HARNESS, DICKEY & PIERCE, P.L.C., P.O. BOX 828, BLOOMFIELD HILLS, MI, 48303, US

(21) Appl. No.: 10/493,375

(22) PCT Filed: Oct. 21, 2002
(86) PCT No.: PCT/US02/33431

(30) Foreign Application Priority Data
Oct. 22, 2001 (US) 60331083

(51) Int. Cl. B60H 1/00

(52) U.S. Cl. 454/118

(57) ABSTRACT

The vent assembly (10) includes a vent frame (14), a vent (16) and a retainer (40). The ven frame attaches to a sidewall (20) of the vehicle. The vent frame defines an opening and includes a projection. The vent is received within the opening and is removably attached to the vent frame. The retainer selectively secures the vent to the vent frame. The retainer is slidably mounted on the vent and is translatable between an engaged position and a non-engaged position. In the engaged position, the vent is secured to the vent frame through engagement of the retainer with the projection of the vent frame. In the non-engaged position, the vent may be removed from the vent frame.

### FIELD OF THE INVENTION

The present invention generally relates to vehicle refrigerators. More particularly, the present invention relates to a vent assembly for a vehicle refrigerator.

### BACKGROUND OF THE INVENTION

Vehicles, including but not limited to recreational vehicles (“RVs” in the United States and “Caravans” in Europe), tractor trailers, airplanes, boats, trains, and the like, often incorporate refrigerators for the comfort and convenience of the occupants. These refrigerators are usually absorption-type refrigerators. An absorption refrigerator includes a heat generator for heating a solution of refrigerant and an absorbent. Heat releases the refrigerant from the absorbent to form a high pressure refrigerant vapor. The refrigerant vapor is condensed in a cooling condenser. Low pressure solution from the heat generator is sprayed on the refrigerant vapor in an absorber to absorb the vapor. The absorption causes the pressure of the vapor to be reduced. Evaporation occurs in an evaporator between the condenser and the absorber. The refrigerant vapor expands in the evaporator which causes a temperature drop in the refrigerant. This temperature drop is used to provide cooling to the refrigerator. The solution of refrigerant and absorbent is then pumped back to the heat generator.

Airflow over the condenser and absorber is conventionally used for cooling of these elements. To create this airflow, a first duct is provided through the coach wall for air intake. An exhaust is provided through a second duct.

While such conventional vent assemblies have proven to be acceptable for their intended uses, they are all associated with limitations. Most significantly insofar as the present invention is concerned, conventional vent assemblies require multiple discrete fasteners for securement to the body of a vehicle. These fasteners are extremely visible and create an undesirable appearance.

Accordingly, it remains a need in the pertinent art to provide a vent assembly for a vehicle refrigerator that overcomes the limitations associated with the prior known arrangements, including but not limited to those disadvantages discussed above.

### SUMMARY OF THE INVENTION

It is an object of the present invention to provide a vent assembly for a vehicle refrigerator that requires a reduced number of discrete fasteners.

It is a related object of the present invention to provide a vent assembly for a vehicle refrigerator having a vent which can be quickly and easily installed/removed and includes no externally visible fasteners.

It is another object of the present invention to provide a vent assembly for a vehicle refrigerator having a removable bug screen.

In one particular form, the present invention provides a vent assembly for a refrigerator of a vehicle. The vent assembly includes a vent frame, a vent and a retainer. The vent frame attaches to a sidewall of the vehicle. The vent frame defines an opening and includes a projection. The vent is received within the opening and is removably attached to the vent frame. The retainer selectively secures the vent to the vent frame. The retainer is slidably mounted on the vent and is translatable between an engaged position and a non-engaged position. In the engaged position, the vent is secured to the vent frame through engagement of the retainer with the projection of the vent frame. In the non-engaged position, the vent may be removed from the vent frame.

Additional advantages and features of the present invention will become apparent from the following description and appended claims, taken in conjunction with the accompanying drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an intake assembly constructed according to the teachings of the present invention shown mounted to a vehicle sidewall.

FIG. 2 is a perspective view of an exhaust vent assembly constructed according to the teachings of the present invention and shown immediately prior to engagement of the vent with a mounting of vent frame of the vent assembly.

FIG. 3 is a cross-sectional view taken along the line 3-3 of FIG. 1.

FIG. 4 is a rear perspective view of a vent according to the teachings of the present invention.

FIG. 5 is an enlarged view of the detail of circle A of FIG. 4

FIG. 6 is a front perspective view of a mounting frame according to the present invention.

FIG. 7 is an enlarged view of the detail of circle B of FIG. 6.

FIG. 8 is a perspective view of a retainer for securing the vent to the mounting frame.

FIG. 9 is a side view of the retainer of FIG. 8.

FIG. 10 is a sectional view taken through a portion of the vent assembly of FIG. 1, illustrating the retainer of FIGS. 8 and 9 translated to a locking position in which the door is secured to the frame.

FIG. 11 is an enlarged rear perspective view of a portion of the cold weather cover illustrating one of its integrally molded tabs.

FIG. 12 is a perspective view similar to FIG. 12 further illustrating engagement of the tab with one of the louver standoffs of the vent.

### DETAILED DESCRIPTION OF THE PREFERRED EMBODIMENTS

The following description of the preferred embodiments of the present invention is merely exemplary in nature and -is in no way intended to limit the invention, its application, or uses.

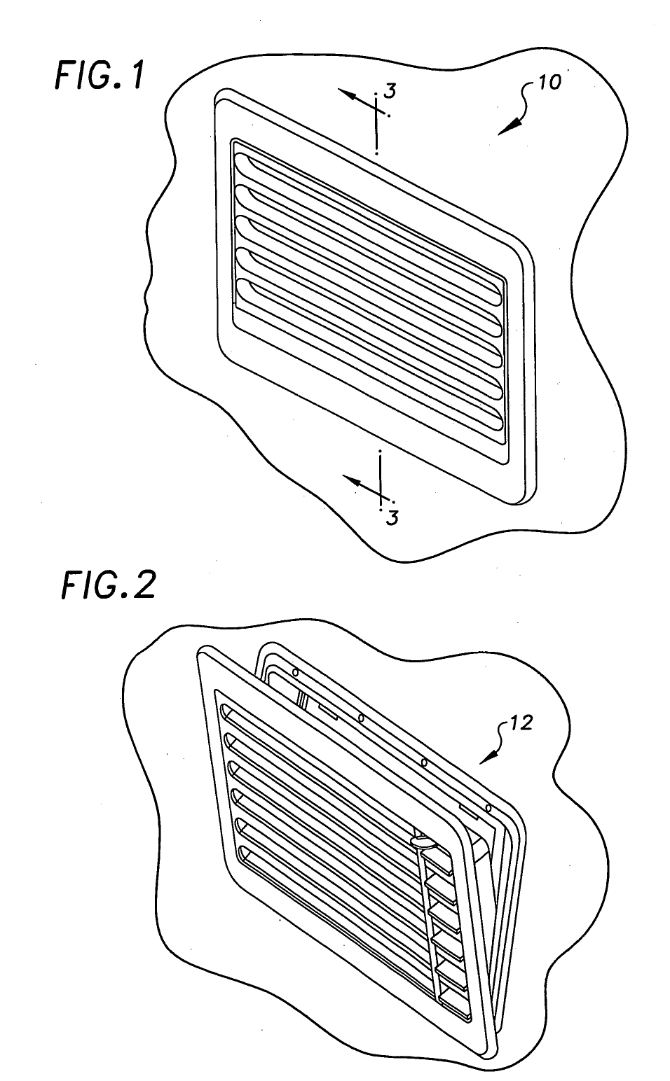

Referring initially to FIGS. 1 and 2, a pair of vent assemblies constructed in accordance with the teachings of the present invention are illustrated and generally identified at reference numbers 10 and 12. The vent assemblies are typically used in pairs. The vent assembly 10 of FIG. 1 is specifically intended for use as an air intake vent assembly 10. The vent assembly of FIG. 2 is specifically intended for use as an exhaust vent assembly 12. The teachings of the present invention are particularly directed to the structure incorporated for connecting the various elements of the vent assemblies 10 and 12. Insofar as the present invention is concerned, these interconnecting components are substantially the same between intake vents (such as that shown in FIG. 1) and exhaust vents (such as those shown in FIG. 2). For this reason, a significant portion of the description provided herein will be directed particularly to the vent assembly 10 shown in FIG. 1.

However, a large portion of these teachings are directly translatable to exhaust vent assemblies. Furthermore, in certain application it may be desirable to utilize a common vent assembly for both intake and exhaust.

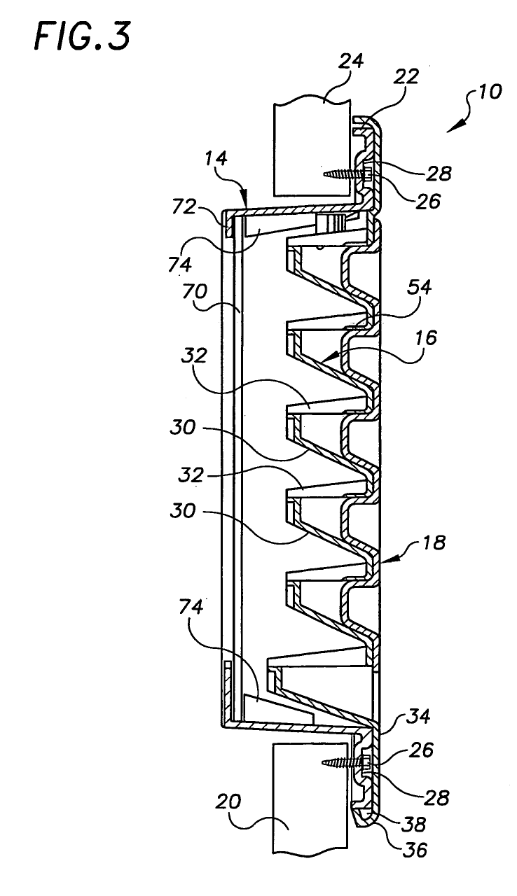

With continued reference to FIGS. 1 and additional reference to FIGS. 3 through 12, the teachings of the present invention will be further addressed. The cross-sectional view of FIG. 3 illustrates the vent assembly 10 to generally include a vent frame or mounting frame 14 and a vent proper or simply vent 16. FIG. 3 additionally illustrates the vent assembly 10 with a cold weather or winter cover 18.

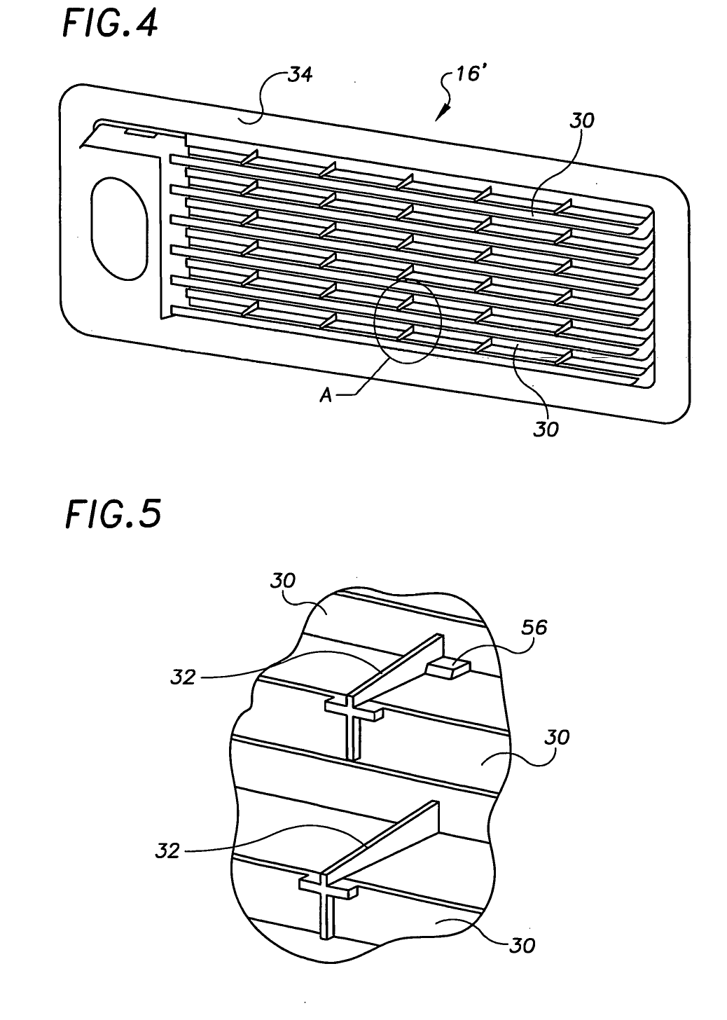

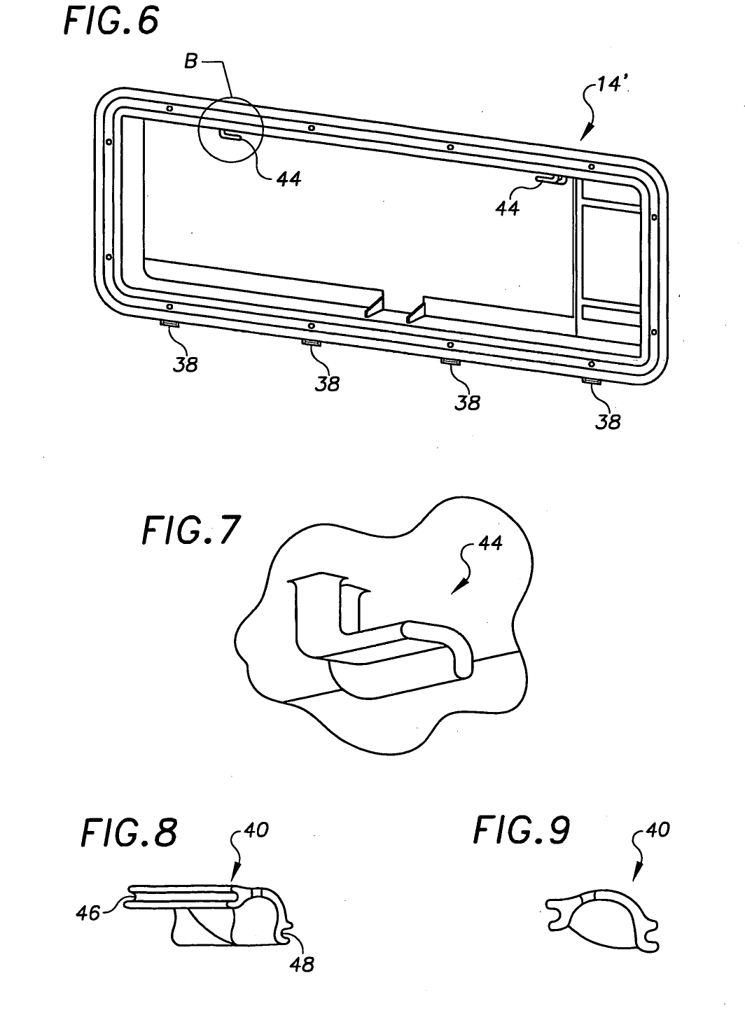

The teachings of the present invention are further illustrated in FIG. 4 which shows a similar vent 16′ specifically for an exhaust application and FIG. 6 which shows a similar vent frame 14′ for an exhaust application. Due to the similarity of these components, like reference numerals are used throughout the drawings to identify substantially identical elements.

As shown in FIG. 3, the vent frame 14 is secured to a sidewall 20 of a vehicle. Specifically, the vent frame includes a mounting flange 22 which abuts an exterior surface of the sidewall 20. Threaded fasteners 26 pass through apertures (not specifically shown) provided in boss portions 28 of the mounting flange 22.

The vent 16 is illustrated to include a plurality of louvers 30. The louvers 30 are aligned parallel relative to one another. Adjacent louvers 30 are interconnected by louver standoffs 32. The louvers standoffs 32 extend in a direction generally perpendicular to the longitudinal axes defined by the louvers 30.

The vent 16 includes a peripheral flange 34 which extends over the mounting portion 22 of the vent frame 14. The peripheral flange 34 is shown to include a generally C-shaped lip 36 which engages integrally formed tabs 38 which downwardly extend from the vent frame 14. The lip 36 and tabs 38 cooperate to retain the vent 16 to the vent frame 14 adjacent the bottom edge of the vent 16. Explaining further, this connection between the vent frame 14 and vent 16 is used to initially engage the components during installation.

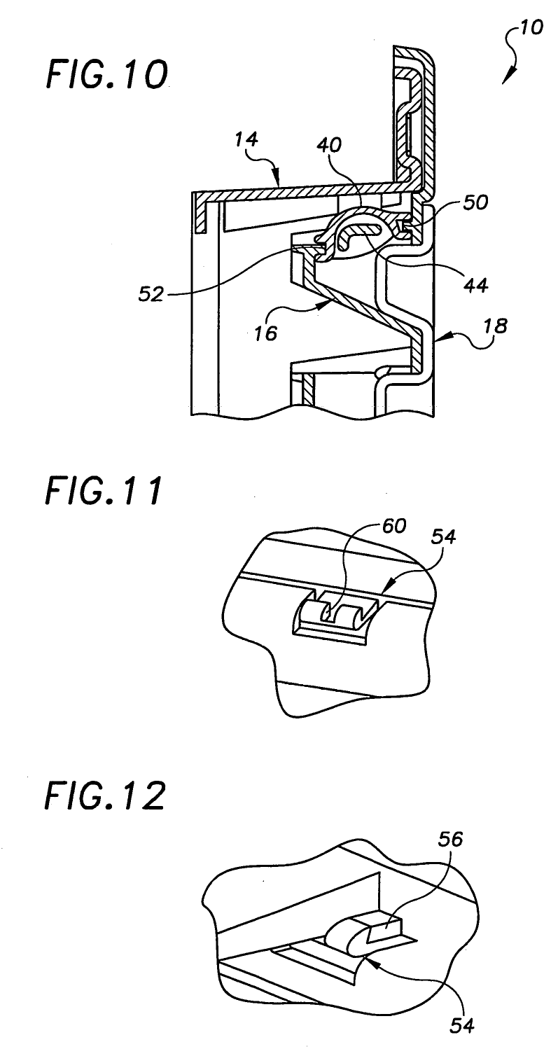

For purposes of further securing the vent 16 to the vent frame 14, the vent assembly 10 of the present invention includes a pair of identical retainers. As such more particularly in the cross-sectional view of FIG. 10, the retainers 40 are slidably retained on the vent 16 for translation between an engaged position and a disengaged position. In the engaged position, the retainer engages a hook member 44 extending from the vent frame 14. In this manner, the retainer 40 secures the vent 16 to the vent frame 14. The retainer 40 defines first and second grooves 46 and 48 (see FIG. 8) which slidably receive first and secorid flanges 50 and 52 of the vent 16. Access to the retainer 40 is provided between the louvers 30 of the vent and as a result, the retainers 40 are not clearly visible from the vehicle exterior.

The winter cover 18 is illustrated to include a plurality of integrally molded tabs 54 (see FIGS. 11 and 12). The tabs 54 include a hook shaped end for snappingly engaging a horizontal segment 56 carried by the louver standoffs 32. The hook portion of the integrally molded tabs 54 is interrupted by a centrally disposed slot 60 which receives one of the louver standoffs 32 so as to laterally locate the cold weather cover 18 relative to the vent 16.

With particular reference to FIG. 3, the vent assembly 10 of the present invention is illustrated to include a removable bug screen 70. The removable bug screen 70 is shown disposed between a rear peripheral flange 72 of the vent frame 14 and a pair of wings 74 carried by the vent frame 14. The removable bug screen 70 preferably includes a semi-rigid frame and a flexible screen proper. The bug screen 70 is quickly and easily removed and installed when the vent 16 is removed from the vent frame 16. By removing the bug screen 70, further ventilation is provided to the refrigerator for more efficient cooling.

The description of the invention is merely exemplary in nature and, thus, variations that do not depart from the gist of the invention are intended to be within the scope of the invention. Such variations are not to be regarded as a departure from the spirit and scope of the invention.

1. A vent assembly for a vehicle refrigerator, the vent assembly comprising:
a vent frame for attachment to a sidewall of the vehicle, the vent frame defining an opening and including a projection;
a vent received within the opening and removably attached to the vent frame; and
a retainer for selectively securing the vent to the vent frame, the retainer slidably mounted on the vent and translatable between an engaged position securing the vent to the vent frame and a non-engaged position permitting removal of the vent from the vent frame, the retainer engaging the projection of the vent frame in the engaged position.

2. The vent assembly for a refrigerator of a vehicle of claim 1, wherein the retainer defines at least one groove for slidably receiving a flange of the vent.

3. The vent assembly for a refrigerator of a vehicle of claim 1, wherein the retainer defines first and second grooves for slidably receiving first and second flanges of the vent.

4. The vent assembly for a refrigerator of a vehicle of claim 1, wherein the vent includes a plurality of louvers and further wherein the retainer is manually accessible between a pair of adjacent louvers of the plurality of louvers.

5. The vent assembly for a refrigerator of a vehicle of claim 1, further comprising a cold weather cover releasably secured to the vent.

6. The vent assembly for a refrigerator of a vehicle of claim 5, wherein the the cold weather covers includes at least one rearwardly extending hook and the vent includes at least one cooperating flange, the hook releasably engaging the flange.

7. The vent assembly for a refrigerator of a vehicle of claim 1, further comprising a removably screen.

8. The vent assembly for a refrigerator of a vehicle of claim 1, wherein the screen is removably attached to the vent frame.

9. The vent assembly for a refrigerator of a vehicle of claim 8, wherein the vent frame includes a pair of inwardly extending wing portions, the removably frame being positioned between the wing portions and a rear peripheral flange.
